(19) United States
(12) Patent Application Publication
(10) Pub. No.: US 2020/0257708 A1
(43) Pub. Date: Aug. 13, 2020

(54) METHOD FOR DYNAMIC ENRICHMENT OF INBOUND TELEPHONE CALLS BASED ON REAL ESTATE LEADS

(71) Applicant: Hoozip Inc., Washington, DC (US)

(72) Inventors: Justin Winthers, Herndon, VA (US); Vincent Harris, Montclair, NJ (US)

(21) Appl. No.: 16/789,367

(22) Filed: Feb. 12, 2020

Related U.S. Application Data
(60) Provisional application No. 62/804,328, filed on Feb. 12, 2019.

(51) Int. Cl. G06F 16/29; G06Q 50/16; H04M 3/42

(52) U.S. Cl. CPC G06F 16/29; H04M 3/42255; H04M 3/42068; G06Q 50/167

(57) ABSTRACT

A method includes: receiving a property address in a real estate campaign, the property address associated with a telephone number; generating a virtual telephone number associated with the real estate campaign; and, at a first time, receiving an incoming call to the virtual telephone number. The method also includes, in response to matching a caller number of the incoming call to the telephone number: retrieving a set of property data items for the property address associated with the telephone number; retrieving a set of demographic data items associated with the telephone number; at a second time within a threshold duration of the first time, displaying the set of property data items and the set of demographic data items at a call enrichment interface; and, at a third time subsequent to the second time, forwarding the incoming call to a marketer telephone number associated with the real estate campaign.

### CROSS-REFERENCE TO RELATED APPLICATIONS

This application is related to U.S. Provisional Application No. 62/804,328, filed on 12 Feb. 2019, which is incorporated in its entirety by this reference.

### TECHNICAL FIELD

This invention relates generally to the field of telephone tracing and more specifically to a new and useful method for marketing return call enrichment in the field of telephone tracing.

### BRIEF DESCRIPTION OF THE FIGURES

FIG. 1 is a flowchart representation of the method; and

FIG. 2 is a schematic representation of the call enrichment interface.

### DESCRIPTION OF THE EMBODIMENTS

The following description of embodiments of the invention is not intended to limit the invention to these embodiments but rather to enable a person skilled in the art to make and use this invention. Variations, configurations, implementations, example implementations, and examples described herein are optional and are not exclusive to the variations, configurations, implementations, example implementations, and examples they describe. The invention described herein can include any and all permutations of these variations, configurations, implementations, example implementations, and examples.

### 1. Method

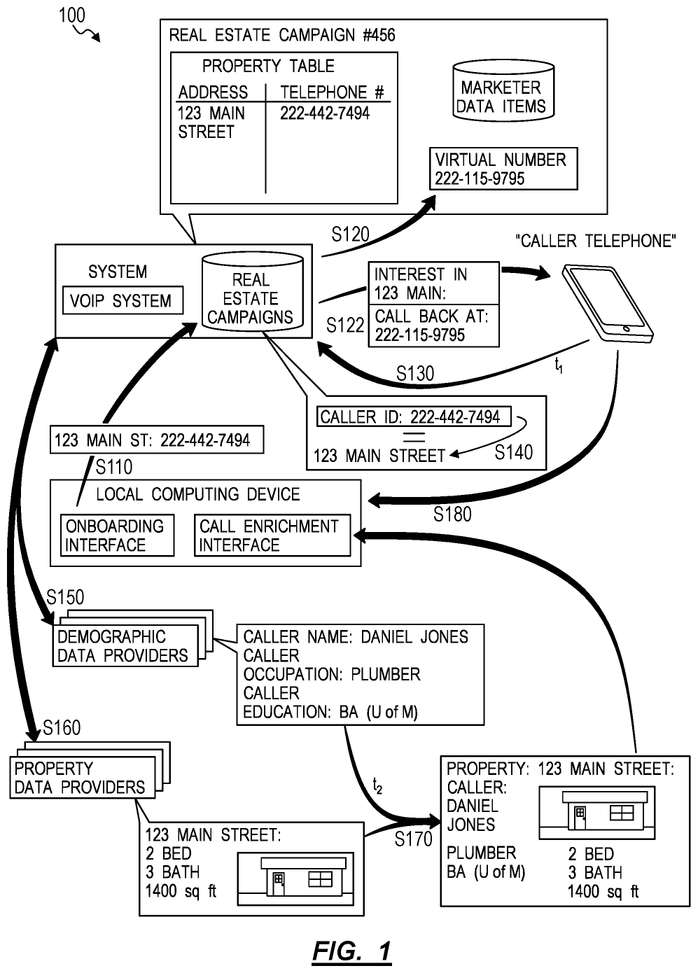

As shown in FIG. 1, a method S100 includes: accessing a property address in a real estate campaign, the property address associated with a telephone number in Block Silo; generating a virtual telephone number associated with the real estate campaign in Block S120; transmitting a personalized message to the telephone number, the personalized message indicating the virtual telephone number S122; and, at a first time, receiving an incoming call to the virtual telephone number in Block S130. The method S100 also includes, in response to matching a caller number of the incoming call to the telephone number in Block S140: retrieving a set of property data items based on the property address in Block S160; retrieving a set of demographic data items based on the telephone number in Block S150; ordering the set of property data items based on a confidence in each property data item in the set of property data items to generate a ranking of property data items; ordering the set of demographic data items based on a confidence in each demographic data item in the set of demographic data items to generate a ranking of demographic data items; displaying the set of demographic data items and the set of property data items based on the ranking of property data items and the ranking of demographic data items; and, at a second time within a threshold duration of the first time, forwarding the incoming call to a marketer telephone number associated with the real estate campaign in Block S180.

As shown in FIG. 1, one variation of the method S100 includes: accessing a property address in a real estate campaign, the property address associated with a telephone number in Block S110; generating a virtual telephone number associated with the real estate campaign in Block S120; transmitting a personalized message to the telephone number, the personalized message indicating the virtual telephone number in Block S122; and, at a first time, receiving an incoming call to the virtual telephone number in Block S130. This variation of the method S100 also includes, in response to matching a caller number of the incoming call to the telephone number in Block S140: retrieving a set of property data items from a set of property data providers based on the property address in Block S160; for each property data item in the set of property data items calculating a confidence score for the property data item based on the set of property data providers, calculating a relevancy score for the property data item based on a set of characteristics of the real estate campaign, and calculating a priority score for the property data item based on the relevance score for the property data item and the confidence score of the property data item; ordering the set of property data items based on the priority score for each property data item in the set of property data items to generate a ranking of property data items; displaying the set of property data items based on the ranking of property data items; and, at a second time within a threshold time period of the first time, forwarding the incoming call to a marketer telephone number associated with the real estate campaign in Block S180.

As shown in FIG. 1, one variation of the method S100 includes: receiving a property address in a real estate campaign, the property address associated with a telephone number in Block S110; generating a virtual telephone number associated with the real estate campaign in Block S120; and, at a first time, receiving an incoming call to the virtual telephone number in Block S130. This variation of the method S100 also includes, in response to matching a caller number of the incoming call to the telephone number in Block S140: retrieving a set of property data items for the property address associated with the telephone number in Block S160; retrieving a set of demographic data items associated with the telephone number in Block S150; at a second time within a threshold duration of the first time, displaying the set of property data items and the set of demographic data items at a call enrichment interface in Block S170; and, at a third time subsequent to the second time, forwarding the incoming call to a marketer telephone number associated with the real estate campaign in Block S180.

### 2. Applications

The method S100 can be executed by a computer system (hereinafter “the system”) such as including one or more computer servers, an internet hosted telephone system (e.g., a server system executing voice over internet protocol, hereinafter “VoIP,” technology), and a local computing device (e.g., a desktop computer, laptop computer, tablet, smartphone) capable of displaying a user interface and connected over a computer network (e.g., the Internet). Generally, the system executes Blocks of the method S100 to provide dynamic enrichment data to a user (e.g., a real estate investor or a real estate agent) in real-time for inbound calls pertaining to a real estate marketing campaign (hereinafter a “campaign”). More specifically, the system can: initiate a campaign by distributing messages to a set of telephone numbers associated with real estate leads (e.g., prospective listings); associate a virtual telephone number with the campaign; detect inbound calls to the virtual telephone number; retrieve property data characterizing a property associated with an inbound caller number, demographic data characterizing an individual associated with the caller number, and campaign data characterizing the campaign of the caller; prioritize and filter the retrieved data based on relevancy of and/or confidence in these data; display these prioritized data to a real estate marketer, such as a real estate agent or a real estate investor (hereinafter “marketer”) via a call enrichment interface; and forward the inbound call to a telephone number associated with the marketer. Therefore, the system can aggregate dynamic, informative, contextual data pertinent to an inbound call related to a real estate investing campaign and serve these data—such as via a call enrichment interface accessed within a native application or web browser—to a marketer in real-time in order to prepare the marketer for upcoming sales calls. Thus, the system can enable a marketer to distribute a large number of initial messages as part of an investing campaign and, upon receiving a return call from a potential seller, leverage data aggregated by the system to quickly build personal rapport and secure a deal with the potential seller.

To initiate a campaign, the system can receive a list or table of property addresses, wherein each address in this list is associated with one or more telephone numbers of property owners or other persons associated with the property (e.g., an executor of a will or trust, a real estate agent responsible for property sale, a relative negotiating on behalf of a property owner, etc.). The system can then define a campaign including the listed property addresses and associated telephone numbers. Once the system has generated a campaign, the system can link a virtual telephone number to the campaign.

The system can then distribute personalized messages (e.g., voice messages, text messages, email messages) to each of the telephone numbers included in the table of property addresses. The system can also communicate the virtual telephone number linked to the campaign in the personalized message, such as via caller ID, direct inclusion within the personalized message, or via other metadata appended to the personalized message. Upon receiving the personalized messages distributed by the system, the property owner (or another associated person) may decide to call the virtual telephone number provided in the personalized message. Furthermore, the marketer may distribute the virtual telephone number linked to the campaign via websites or website advertisements, physical signs, postcards, and/or any other type of media.

Later, when the system receives a call—from an inbound telephone number—at the virtual telephone number, the system can identify the campaign based on the virtual telephone number. Furthermore, the system can match the inbound telephone number to a telephone number listed in the table of telephone numbers associated with the campaign to identify a particular property associated with the caller.

Upon identifying the campaign and the particular property associated with the inbound telephone number, the system can retrieve property data representative of the affiliated property, demographic data representative of a caller associated with this inbound telephone number, and/or campaign data indicating the status of the property. For example, the system can retrieve property data, such as the address of the property, an image of the property, a floor area (e.g., square-footage) of the property, a number of bedrooms and/or bathrooms of the property, an approximate monetary value of the property, a summary of comparable properties, etc. The system can also retrieve demographic data associated with the telephone number, such as a name of the caller, an age of the caller, a picture of the caller, a job of the caller, interests of the caller, education of the caller, social media accounts associated with the caller, etc.

The system can retrieve these data from multiple data providers, such as via a series of application programming interface (hereinafter “API”) calls to each of these data providers. The system can also retrieve data of the same types (e.g., caller name, gender, occupation, or city of residence; property states and last appraised value) from multiple data providers, compare data of the same types, and thus verify these data in order to improve reliability of these data before serving these verified data to the marketer.

Furthermore, the system can retrieve campaign data associated with the property of a caller by referencing an internal database stored by the system. For example, the system can: store notes and other information describing previous inbound calls associated with the a particular property, sentiments of these calls, progress and/or status of any offers made during these previous calls, etc., such as entered manually into the call enrichment interface by the marketer; and then retrieve and present these data to the marketer when a call from a telephone number associated with this property is later inbound to the virtual telephone numbers. Similarly, when more than one telephone number is associated with a property, the system can identify calls from multiple different telephone numbers that are relevant to the same property and consequently provide information about previous calls related to a particular property upon receiving a next inbound call from a telephone number associated with the same property.

After aggregating relevant data pertaining to the property, the caller, and the campaign, the system can evaluate and display relevant and accurate portions of the retrieved data at a call enrichment interface. In one variation, the system: weights the data items based on their relevancies and confidence scores for accuracy of these data items; and displays these data items ordered by weight at the top of the call enrichment interface. In another variation, the system populates a predefined display configuration within these data items and removes or obscures data items associated with lower confidence scores (e.g., confidence scores below a threshold). For example, the system can display a call enrichment interface that includes the name, age, and occupation of the caller at the top of the interface while displaying a picture of the property, an approximate monetary value of the property, a short description of the property, and a campaign history of the campaign associated with the property. The system can additionally or alternatively display an interactive call enrichment interface that renders more detailed caller-, property-, and/or campaign-related data in response to inputs from the user. For example, the system can display additional pictures of the property within the interactive call enrichment interface in response to the user clicking on a hero image of the property.

After or while populating the call enrichment interface with these data and serving the call enrichment interface to the marketer, the system can forward the inbound call to a telephone number associated with the marketer. Therefore, the system can provide contextual data associated with the property, the caller, and the campaign to the marketer before the marketer accepts the inbound call. The system can also implement a short delay (e.g., a preset delay of up to five seconds) between an initial time of the inbound call to the virtual telephone number and a time that the inbound call is passed to the marketer's telephone number in order to allow the marketer to review data within the call enrichment interface before accepting the inbound call.

In one implementation, the system can receive and store an input of data characterizing the marketer (e.g., via an input interface) in order to inform the system of information that may facilitate a sale of the property. For example, the system can provide an onboarding interface to allow the marketer to provide detailed information about themselves (e.g., the marketer's educational history, resident city, and interests). Therefore, when the system displays the call enrichment interface to the marketer for an inbound call, the system can display data that is similar between the caller and the marketer (e.g., the system can indicate that the caller and the marketer went to the same high school, have similar interests).

In another implementation, if the system has received multiple calls from more than one caller associated with the same property, the system can identify the relationship between each of the callers. For example, the system can identify that a first caller is the property owner and that the second caller is the spouse of the property owner.

In yet another implementation, the system can generate data based on the content of the conversation between the caller and the marketer during the call, such as the sentiment of the call, the talking duration of each participant in the call, and any agreements reached or conclusions made during the call. Furthermore, the system can provide notes and/or fillable forms to the marketer via the call enrichment interface in order to enable the marketer to store any relevant information about the call.

### 3. Marketer Onboarding

In one implementation, the system can render, at a local computing device, an onboarding interface for a marketer using the system. Generally, the onboarding interface enables the marketer to input personal details, such that the system can better select relevant information associated with a caller to display in the call enrichment interface upon receiving a call for a campaign. The onboarding interface can provide a number of text input fields, drop-down menus, or any other common user interface feature with which the marketer can input personal data. Additionally or alternatively, the system can import personal data associated with the marketer by interfacing (e.g., via an API call) with common social media platforms. Furthermore, the system can provide a mandatory input field for a telephone number of the marketer.

Upon receiving personal data associated with the marketer, the system can store these data in association with a marketer profile and/or with a specific campaign and therefore utilize these data when calculating the relevancy of various data items that can be displayed in the call enrichment interface. For example, the system can display or render information that may aid the marketer in forming a positive relationship with a caller at the top of the call enrichment interface.

Thus, the system can: prompt a marketer to input a set of marketer data items via an onboarding interface, the set of marketer data items representing personal information associated with the marketer. The system can then compare the set of marketer data items to a set of demographic data items associated with a telephone number of an incoming call in order to detect similarities between the marketer data items and the demographic data items by, for each demographic data item, calculating a relevancy score for the demographic data item based on a similarity between the demographic data item and a corresponding marketer data item in the set of marketer data items. Upon calculating a relevancy score for each demographic data item, the system can render or display the more relevant demographic data items closer to the top of the call enrichment interface such that they may be viewed first by the marketer upon receiving the incoming call. More specifically, the system can order the set of demographic data items based on the confidence score for each demographic data item and the relevancy score for each demographic data item to generate the ranking of demographic data items.

For example, the system can compare a marketer data item describing the marketer's educational history and detect a match with a demographic data item describing an educational history associated with the telephone number of the incoming call, thereby indicating that the marketer and the incoming caller may have attended the same school. The system can then render or display the caller's educational history prominently in the call enrichment interface.

### 4. Campaign Initialization

Generally, the system can initiate a campaign for soliciting the sale of a set of real estate properties. More specifically, the system, or an associated system, can initialize a real estate investment campaign by: receiving a property table listing a set of addresses and associated telephone numbers in Block S110; linking a virtual telephone number for the campaign in Block S120; and distributing a set of personalized messages to each of the associated telephone numbers in Block S122.

In Block S110, the system can receive a list of addresses and associated telephone numbers in any standard data format (e.g., a CSV file) that can represent a list of addresses and then associate each address in the list of addresses with a set of telephone numbers (e.g., one or more). Additionally or alternatively, the system can provide an import interface enabling the marketer to upload or otherwise import the property table into the system. In one implementation, the system can receive only a list of addresses (i.e. without associated telephone numbers) and obtain the associated telephone numbers via an API call to a particular data provider storing telephone records in association with property records. More specifically the system can: request telephone numbers associated with each property address from a data provider storing telephone numbers associated with property addresses; receive the telephone number from the data provider storing telephone numbers associated with property addresses; and store the telephone number in association with the property address in the real estate campaign.

Upon receiving the property table in a supported format, the system can create a campaign profile and associate the campaign profile with the property table. In one implementation, the system can also associate the campaign profile with a set of previously-created marketer profiles representing marketers who may be receiving calls in the campaign.

Upon creating a campaign profile for the campaign, the system generates a virtual telephone number for the campaign and associates the virtual telephone number with the campaign profile in Block S120. The system can generate the virtual telephone number utilizing any VoIP system to request a new number from the telephone provider. In one implementation, the system can generate multiple virtual numbers for a single campaign and associate each of the generated virtual telephone numbers with one campaign profile. For example, the system can generate a virtual telephone number for each area code corresponding to the addresses associated with a campaign such that, when the system distributes personalized messages to the set of telephone numbers associated with each address, the system can provide a callback number via the personalized message that has the same area code of the address where the property is located. In an alternative example, the system can generate a set of virtual telephone numbers with area codes matching the area codes of each telephone number included in the property table associated with the campaign.

After linking the virtual telephone number to the campaign, the system, or an associated system (e.g., a separate recorded voice message system or call system), can distribute a personalized message to each address in the property table in Block S122. The personalized message can be any type (or multiple types) of message. In one example, the system or associated system, can distribute personalized recorded voice messages as the personalized messages. The personalized messages can include a short description of the property and/or the address, include a solicitation to buy the property, and recite the virtual telephone number as a callback number.

In one implementation, the system can retrieve name information for each of the telephone numbers in the property table prior to distributing a personalized message to each telephone number. The system can thus distribute personalized messages that address the property owner (or any other person associated with the property) by name. In another implementation, the system can provide an interface to input offers for each property into the campaign and, therefore, can include an offer to purchase each property in the personalized message.

### 5. Call Detection and Property Identification

Generally, the system detects inbound calls to the virtual number in Block S130 and identifies the campaign and property associated with the inbound call. More specifically, the system can: receive an inbound call at the virtual number; determine a inbound telephone number from the inbound call via caller identification; match the calling number to the telephone numbers stored in the property table associated with the campaign profile that is also associated with the virtual number receiving the call in Block S140; and identify the property associated with the matched telephone number.

Upon receiving the inbound call, the system retrieves the campaign profile associated with the virtual telephone number at which the call was received. The system can simultaneously implement standard caller identification techniques, such as Bellcore FSK, DTMF, ETSI FSK, etc. in order to identify the inbound telephone number of the inbound call. Upon identifying the inbound telephone number, the system retrieves the property table stored in association with the campaign profile of the virtual telephone number and executes a search algorithm to match the inbound telephone number with a telephone number in the property table. The system can therefore identify the property that is associated with the inbound call.

However, the system can detect an inbound call and identify an associated property based on the property table in any other way.

### 6. Data Acquisition

Once the inbound telephone number, the associated property, and the associated campaign have been identified, the system retrieves data pertaining to each of the above aspects corresponding to the inbound call. More specifically, the system can retrieve: a set of demographic data items based on the inbound telephone number in Block S150; a set of property data items based on the address associated with the inbound telephone number in Block S160; and a set of campaign data items associated with the inbound telephone number. The system can retrieve data upon identifying the property associated with the inbound telephone number and can do so in real time before forwarding the call to the marketer. Thus, the system ensures that the retrieved data is up to date. Furthermore, because the system retrieves data in real time, the system can temporarily store the retrieved data before subsequently removing the data from temporary storage in order to reduce storage usage of the system.

In order to obtain relevant and comprehensive datasets for display to the marketer, the system can retrieve data from multiple data providers substantially simultaneously. For example, the system can sequentially (and substantially simultaneously) send requests for information to multiple data providers over the internet or a private network (e.g., via HTTP request, API request). Upon receiving responses from each data provider, the system can normalize and further categorize the data received from the data providers as described further below. In one implementation, the system can continue to populate the call enrichment interface as it receives additional data from the set of data providers, even after forwarding the call to the telephone number associated with the marketer.

In one implementation, the system can include the responses of some data providers (primary data providers) in requests made to secondary data providers. For example, the system can submit a request including the inbound telephone number to a primary data provider. The primary data provider can retrieve a name of an individual associated with the inbound telephone number. The system can then include the name of the individual and the address in a request to a secondary data provider. The secondary data provider can then retrieve a job description and social network information of the individual. Furthermore, in addition to retrieving data, the data providers can also indicate a confidence score associated with each item of data so that the system can prioritize data items with a higher probability of accuracy for display within the call enrichment interface.

### 6.1 Demographic Data Items

The system can retrieve demographic data based on the inbound telephone number (i.e. the telephone number associated with a property owner) in Block S150. More specifically, the system can retrieve a set of demographic data items based on the inbound telephone number from a set of demographic data providers. Thus, the system transmits requests to each demographic data provider in the set of data providers, wherein the request includes the inbound telephone number. The system can retrieve, from the set of demographic data providers, demographic data characterizing an individual associated with the inbound telephone number. The system can then receive, from the set of demographic data providers, additional information pertaining to the individual associated with the telephone number such as the age of the individual, picture(s) of the individual, a job of the individual, a job history of the individual, an educational history of the individual, interests of the individual derived from publicly available social media information, social media accounts associated with the individual, or any other personal information that may be relevant to the solicitation of the sale of the property associated with the inbound telephone number. For example, the system can retrieve, from the set of demographic data providers: a caller name, a caller age, a caller occupation, a caller educational history, and caller interests based on the telephone number.

In one implementation, the system can also request demographic data for other telephone numbers in the property table that are associated with the same property as the inbound telephone number. The system can then receive, from the set of demographic data providers, additional data for individuals associated with the other telephone numbers corresponding to the property address.

In another implementation, the system can request a name associated with an inbound telephone number from a primary demographic data provider prior to requesting social media information (or other personal information) from a secondary demographic data provider. More specifically, the system can: request a name associated with the telephone number from a data provider storing names associated with telephone numbers based on the telephone number; receive a caller name associated with the telephone number, from a primary demographic data provider; request social media data associated with the caller name from a social media platform based on the caller name; and receive the set of demographic data items from the social media platform.

### 6.2 Property Data Items

The system can retrieve property data based on the property address associated with the inbound telephone number according to the property table in Block S160. More specifically, the system can retrieve a set of property data items based on the property address. Thus, the system transmits requests to each property data provider in a set of property data providers, wherein the request includes the address associated with the inbound telephone number. The system retrieves, from the set of property data providers, a set of property data items characterizing the property located at the requested address such as one or more images of the property, the floor area (e.g., square-footage) of the property, the plot area (e.g., acreage) of the property (if applicable), the number of bedrooms, bathrooms, and/or total rooms in the property, the approximate monetary value of the property, a list of similar properties, tax records for the property, utility records for the property (e.g., electric, water, gas, etc.), school district information associated with the property, additional features of the property (e.g., pool, fireplace, basement, or anything not pictured), a map of the area surrounding the property, or any other information pertaining to the property.

In one implementation, the system can request additional property data items pertaining to each of the similar properties included in the retrieved list of similar properties. More specifically, the system can retrieve a set of property data items including a subset of property data items associated with a similar real estate listing to the property at the property address. Thus, the marketer can view data for any similar listing displayed in the call enrichment interface. In one example, the system can request and retrieve property data items from similar listings by extracting characteristics of the property at the property address such as a number of bedrooms, a number of bathrooms, a floor area, a lot area, an architectural style, a set of amenities, and request listings from a listing data provider with matching or similar characteristics. The system can then calculate a similarity metric between each retrieved similar listing and the property at the property address and render listings characterized by a similarity metric exceeding a threshold similarity metric.

In another implementation, the system can retrieve and/or calculate an approximate monetary value associated with the property address based on listed prices of similar listings in the area. More specifically, the system can retrieve the set of property data items from the set of property data providers based on the property address, the set of property data items comprising an approximate monetary value associated with the property address. Additionally or alternatively, the system can calculate the approximate monetary value of the property associated with a property address by: identifying a set of similar listings exceeding a threshold similarity metric; and calculating the approximate monetary value of the monetary values of the set of similar listings. For example, the system can calculate a weighted average of the monetary values of the set of similar listings, where each monetary value of a listing is scaled by the similarity metric of that listing relative to the property associated with the property address.

In yet another implementation, the system can retrieve the set of property data items from the set of property data providers based on the property address, the set of property data items including: a set of images associated with the property address; a floor area associated with the property address; a plot size associated with the property address; a number of bathrooms associated with the property address; a number of bedrooms associated with the property address; a number of total rooms associated with the property address; utility records associated with the property address; school district information associated with the property address; and a map of a region associated with the property address.

### 6.3 Campaign Data Items

The system can retrieve (e.g., from an internally managed database) campaign data specific to the property and for the campaign as a whole. More specifically, the system can retrieve a set of campaign data items such as: the type of campaign (e.g., a probate campaign, a tax delinquency campaign, a utility delinquency campaign, a foreclosure campaign, etc. and/or some combination of the aforementioned campaigns), the total amount of capital allocated to the campaign, the remaining uninvested capital for the campaign, and/or any other information pertinent to the campaign. In one example, the system can retrieve a set of campaign data items including: a type of the real estate campaign; a capital allocation of the real estate campaign; and a remaining uninvested capital of the real estate campaign.

Additionally the system can retrieve a set of campaign data items specific to the property or property address such as a list of previous calls associated with the property, the date and time of those calls, the duration of those calls, the inbound telephone number and name associated with those calls, the sentiment of those calls, any offers made on the property (including outstanding bids from other marketers), and/or any other notes or other information associated with the particular property and the campaign. Thus, the system can retrieve call data associated with the property regardless of whether the relevant call was made by the same caller or received by the same marketer as the current call (e.g., if there are multiple marketer telephone numbers and/or other telephone numbers associated with the property).

The system can collect a set of campaign data items by automatically recording and/or analyzing previous calls made between the telephone number of the caller and the virtual telephone number and/or between another telephone number associated with the property address and the virtual telephone number. More specifically, the system can: record a set of campaign data items based on a first incoming call from a first telephone number associated with a property address; store the set of campaign data items in association with the first telephone number and/or the property address associated with the first telephone number; and, at a later time, receive a second incoming call to the virtual telephone number. The system can then, in response to matching a second caller number of the second incoming call to the first telephone number and/or the property address associated with the first telephone number: retrieve an updated set of property data items for the property address associated with the telephone number; retrieve an updated set of demographic data items associated with the telephone number; retrieve the set of campaign data items associated with the telephone number; display the set of property data items, the set of demographic data items, and the set of campaign data items at the call enrichment interface; and forward the second incoming call to a marketer telephone number associated with the real estate campaign. Thus, the system can: record a duration of the incoming call; record a date and time of the incoming call; detect a sentiment of the incoming call; record an outstanding offer for the property address made during the incoming call; and present these campaign data items in the call enrichment interface upon receiving a future call from a number associated with the same property address.

### 7. Data Prioritization

Upon receiving the set of demographic data items, the set of property data items, and/or the set of campaign data items from the set of data providers, the system can prioritize and/or filter the retrieved data before presenting the data via the call enrichment interface (as further described below) and Block S162. More specifically, the system can order the set of demographic data items based on a confidence in each demographic data item in the set of demographic data items to generate a ranking of demographic data items; and order the set of property data items based on a confidence in each property data item in the set of property data items to generate a ranking of property data items. Additionally, the system can: for each property data item in the set of property data items calculate a confidence score for the property data item based on the set of property data providers, calculate a relevancy score for the property data item based on a set of characteristics of the real estate campaign, and calculate a priority score for the property data item based on the relevance score for the property data item and the confidence score of the property data item.

In one implementation, the system can calculate a priority score or weight for each data item to be displayed in the call enrichment interface. The system can calculate the priority score based on a confidence score assigned to the data item by a data provider. Furthermore, the system can adjust the confidence score of a data item based on corroborating data (or a lack thereof) retrieved from separate data providers. Thus, the system can better verify the accuracy of individual data items when compared to the nominal confidence scores assigned by the data provider of the data item.

When identifying corroborating data providers for a data item, the system can establish a similarity threshold for each type of data item. For example, the system can identify a first data provider and a second data provider each provide the same type of data item as corroborating data items in response to calculating that a first data item retrieved from the first data provider is within a threshold variation (e.g., a proportional variation or a marginal variation) from the second data item provided by the second data provider. For categorical data items, the system can identify corroborating data providers based on matches between retrieved categories of data items retrieved from separate data providers.

In one example, the system can: identify a set of corroborating property data providers in the set of property data providers for the property data item; access a set of nominal confidence scores for the set of corroborating property data providers; and calculate the confidence score for the property data item based on the set of corroborating property data providers and the set of nominal confidence scores for the set of corroborating property data providers. Thus, the system can calculate higher confidence scores in response to a higher value of nominal confidences scores issued by each data provider and a larger number of corroborating data providers for a single data item.

In another example, the system can calculate confidence scores for property data items or demographic data items based on the historical accuracy of the data providers of each data item. More specifically, the system can: identify a set of corroborating property data providers in the set of property data providers for the property data item; access a set of accuracy weights for the set of corroborating property data providers; and calculate the confidence score for the property data item based on the set of corroborating property data providers and the set of accuracy weights for the set of corroborating property data providers. Thus, the system can track the accuracy of each data provider over time and scale the confidence scores calculated for each data item retrieved from the data provider by this accuracy score.

In yet another example, the system can detect matches between data item values for a particular data item provided by multiple data providers. For example, if the system retrieves a first value for the floor area of a property from three data providers and a second value for the floor area of the property from only one data provider, the system can assign a higher confidence score to the first value of the floor area and prioritize display of this data item in the call enrichment interface. The system can also take into account the nominal confidence scores reported by each data provider and/or the historical accuracy weight calculated for the data provider. More specifically, with respect to property data items, the system can: request the set of property data items from a set of property data providers based on the property address; for each property data item in the set of property data items, receive the property data item from a corresponding subset of property data providers in the set of property data providers; for each property data item in the set of property data items, calculate a confidence score based on a size of the corresponding subset of property data providers, an accuracy weight of each property data provider in the corresponding subset of property data providers, and/or a nominal confidence score assigned to the property data item by each property data provider in the corresponding subset of property data providers; and generate the ranking of property data items based on the confidence score of each property data item. With respect to demographic data items, the system can: request the set of demographic data items from a set of demographic data providers based on the telephone number; and for each demographic data item in the set of demographic data items, receive the demographic data item from a corresponding subset of demographic data providers in the set of demographic data providers; for each demographic data item in the set of demographic data items, calculate a confidence score based on a size of the corresponding subset of demographic data providers, an accuracy weight of each demographic data provider in the corresponding subset of demographic data providers, and/or a nominal confidence score assigned to the property data item by each property data provider in the corresponding subset of property data providers; and generate the ranking of demographic data items based on the confidence score of each demographic data item.

Additionally or alternatively, the system can calculate a relevancy score for each data item based on the type of campaign, the similarity of a demographic data item to a corresponding marketer data item input via the onboarding interface, and/or any other aspect of the property, campaign, or individual associated with the inbound telephone number. In yet another implementation, the system can set a base relevancy score according to the type of data item (e.g., the system can assign high relevancy to the name of the individual associated with the inbound telephone number). For example, based on the type of real estate campaign corresponding to the virtual telephone number, the system can assign default relevancy scores to particular types of property data items.

In this implementation, the system can calculate a similarity metric between two like demographic data items and calculate a relevancy score based on this similarity metric. The system can execute various similarity metric calculations depending on the type of demographic data item being compared. For example, the system can calculate a similarity metric for current residency data items based on the geographic distance between a residency associated with the caller and a residency associated with the marketer. In another example, the system can calculate a similarity metric between an educational history data item for the caller and an educational history data item for the marketer based on the type of each school, the geographic distance between each school, the size of each school, etc.

In one implementation, the system can calculate the priority score as a function of the confidence score and/or the relevancy score (e.g., an average or weighted average function of the relevancy score and the confidence score). More specifically, the system can, in response to the caller number of the incoming call matching the telephone number: retrieve a set of demographic data items from a set of demographic data providers based on the caller number; for each demographic data item in the set of demographic data items calculate a confidence score for the demographic data item based on the set of demographic data providers and calculate a relevancy score for the demographic data item based on similarities between a corresponding marketer data item and the demographic data item. The system can then calculate a priority score for the demographic data item based on the relevance score for the demographic data item and the confidence score of the demographic data item.

The system can then rank the data items according to their priority score and organize the call enrichment interface based on the ranking of the data items. Additionally or alternatively, the system can remove or filter data items from the call enrichment interface if the priority score of the data items is below a threshold priority score. More specifically, the system can: order the set of demographic data items based on the priority score for each demographic data item in the set of demographic data items to generate a ranking of demographic data items; and display the set of demographic data items based on the ranking of demographic data items. Likewise, the system can execute the above steps for the set of property data items.

### 8. Call Enrichment Interface

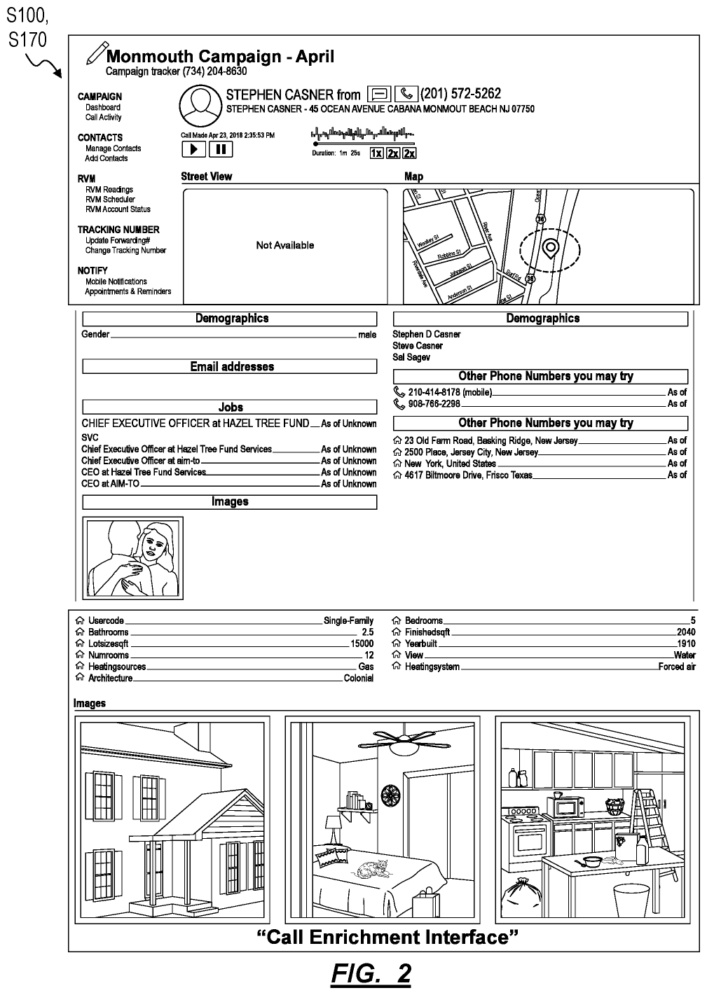

As shown in FIG. 2, the system displays the set of demographic data items, the set of property data items, and/or the set of campaign data items from the retrieved demographic data, property data, and campaign data respectively in a readable format for the marketer to view via a call enrichment interface displayed on a local computing device in Block S170. Additionally, the system can display the set of demographic data items and the set of property data items based on the ranking of property data items and the ranking of demographic data items. Therefore, the call enrichment interface prominently displays high priority data items (e.g., at the top of the window, graphically highlighted) while displaying lower priority data items in less prominent locations. More specifically, the system can: rank a set of demographic data items and a set of property data items based on a priority score for each demographic data item in the set of demographic data items and for each property data item in the set of property data items; and display the set of demographic data items higher in the call enrichment interface based on the ranking of demographic data items; and display the set of property data items higher in the call enrichment interface based on the ranking of property data items.

In one implementation, the system displays and/or renders the call enrichment interface in a scrollable window and lower priority data items are displayed outside of the scrolling window of the call enrichment interface. In other implementations, the data items are displayed in order of priority, confidence, or relevancy.

In another implementation, the system can initially store some lower priority data items in a location accessible to the call enrichment interface but not displayed in the call enrichment interface. The marketer can then access the additional data by interacting with the call enrichment interface (e.g., via clicking, hovering-over, scrolling) Furthermore, the call enrichment interface can indicate any data item with a color, symbol, or graphical representation the data item.

In yet another implementation, the call enrichment interface can include summary statistics of a real estate market associated with the property in the call enrichment interface and can display the summary statistics in an appropriate chart, histogram, etc.

In another implementation, the call enrichment interface can include a visualization or timeline of previous calls and/or other points of contact (e.g., initial personalized messages, offers made). Additionally or alternatively, the call enrichment interface can display interfaces to enable the marketer to record notes, indicate terms of a potential agreement, indicate overall sentiment of the conversation, etc. The call enrichment interface can then display those notes in a subsequent call associated with the same property.

In one example, the system can: display the call enrichment interface including: the set of property data items including a set of images associated with the property address, a floor area associated with the property address, and an approximate monetary value of the property address; and the set of demographic data items including a name associated with the telephone number, an employment history associated with the name, and a residential address associated with the name.

In one implementation, the system can render and/or display the call enrichment interface within a threshold duration of time after receiving the call, in order to minimize the wait time for the incoming caller prior to connecting to the marketer over the VoIP system. Additionally, the system can render and/or display the call enrichment interface prior to collection of all property, demographic, and/or campaign data items and can continue to update the call enrichment interface as the marketer speaks with the caller over the telephone.

### 9. Call Forwarding and Call Logging

Generally, upon displaying the call enrichment interface, the system forwards the call from via the virtual telephone number to a telephone number associated with the marketer according to the marketer profile in Block S180. In one implementation, the system can execute a short delay (e.g., five seconds, ten seconds) prior to displaying the call enrichment interface and forwarding the inbound call in order to provide time for the marketer to review data displayed in the call enrichment interface and prepare to answer the call. In another implementation, the system can receive an input from the marketer that she is ready to take the call via a user interface element displayed in the call enrichment interface. In response to receiving the input from the marketer, the system can forward the call to the telephone number associated with the marketer.

In one implementation, the system can render and/or display the call enrichment interface at the same device that the system also forwards the incoming call. Therefore, a marketer can view the call enrichment interface and answer the incoming call via the same computational device (e.g., a tablet, smartphone, or desktop computer). More specifically, the system can: within the threshold duration of receiving the incoming call, display the set of property data items and the set of demographic data items at the call enrichment interface at a computational device; and forward the incoming call to the marketer telephone number associated with the real estate campaign further comprises, at the third time subsequent to the second time, forwarding the incoming call to the computational device.

Once the marketer answers the telephone, the system can log the conversation to determine: the duration of the conversation, the sentiment of the conversation, the talking duration of each participant in the conversation, or any other detectable information in the conversation. In one implementation, the system performs natural language processing techniques to facilitate the abovementioned call logging. The system can then store the logged call data in association with the property. The system can therefore, upon receiving a subsequent call associated with the same property, retrieve these data items generated by the call logging system and present these data items as campaign data in the call enrichment interface for the subsequent call.

The systems and methods described herein can be embodied and/or implemented at least in part as a machine configured to receive a computer-readable medium storing computer-readable instructions. The instructions can be executed by computer-executable components integrated with the application, applet, host, server, network, website, communication service, communication interface, hardware/firmware/software elements of a user computer or mobile device, wristband, smartphone, or any suitable combination thereof. Other systems and methods of the embodiment can be embodied and/or implemented at least in part as a machine configured to receive a computer-readable medium storing computer-readable instructions. The instructions can be executed by computer-executable components integrated by computer-executable components integrated with apparatuses and networks of the type described above. The computer-readable medium can be stored on any suitable computer readable media such as RAMs, ROMs, flash memory, EEPROMs, optical devices (CD or DVD), hard drives, floppy drives, or any suitable device. The computer-executable component can be a processor but any suitable dedicated hardware device can (alternatively or additionally) execute the instructions.

As a person skilled in the art will recognize from the previous detailed description and from the figures and claims, modifications and changes can be made to the embodiments of the invention without departing from the scope of this invention as defined in the following claims.

I claim:

1. A method comprising:
accessing a property address in a real estate campaign, the property address associated with a telephone number;
generating a virtual telephone number associated with the real estate campaign;
transmitting a personalized message to the telephone number, the personalized message indicating the virtual telephone number;
at a first time, receiving an incoming call to the virtual telephone number;
in response to matching a caller number of the incoming call to the telephone number:
retrieving a set of property data items based on the property address;
retrieving a set of demographic data items based on the telephone number;
ordering the set of property data items based on a confidence in each property data item in the set of property data items to generate a ranking of property data items;
ordering the set of demographic data items based on a confidence in each demographic data item in the set of demographic data items to generate a ranking of demographic data items;
displaying the set of demographic data items and the set of property data items based on the ranking of property data items and the ranking of demographic data items; and
at a second time within a threshold duration of the first time, forwarding the incoming call to a marketer telephone number associated with the real estate campaign.

2. The method of claim 1:
further comprising prompting a marketer to input a set of marketer data items via an onboarding interface;
wherein ordering the set of demographic data items based on the confidence in each demographic data item in the set of demographic data items to generate the ranking of demographic data items further comprises:
for each demographic data item:
calculating a confidence score for the demographic data item; and
calculating a relevancy score for the demographic data item based on a similarity between the demographic data item and a corresponding marketer data item in the set of marketer data items; and
ordering the set of demographic data items based on the confidence score for each demographic data item and the relevancy score for each demographic data item to generate the ranking of demographic data items.

3. The method of claim 1, wherein accessing the property address in the real estate campaign, the property address associated with the telephone number further comprises:
requesting telephone numbers associated with the property address from a data provider storing telephone numbers based on the property address; and
receiving the telephone number from the data provider storing telephone numbers; and
storing the telephone number in association with the property address in the real estate campaign.

4. The method of claim 1, wherein retrieving a set of demographic data items based on the telephone number further comprises:
requesting a name associated with the telephone number from a data provider storing names associated with telephone numbers based on the telephone number;
receiving a caller name associated with the telephone number;
requesting social media data associated with the caller name from a social media platform based on the caller name; and
receiving the set of demographic data items from the social media platform.

5. The method of claim 1, wherein retrieving the set of demographic data items based on the telephone number further comprises retrieving a caller name, a caller age, a caller occupation, a caller educational history, and caller interests based on the telephone number.

6. The method of claim 1:
wherein retrieving the set of property data items based on the property address further comprises:
requesting the set of property data items from a set of property data providers based on the property address; and
for each property data item in the set of property data items, receiving the property data item from a corresponding subset of property data providers in the set of property data providers;
wherein retrieving the set of demographic data items based on the telephone number further comprises:
requesting the set of demographic data items from a set of demographic data providers based on the telephone number; and
for each demographic data item in the set of demographic data items, receiving the demographic data item from a corresponding subset of demographic data providers in the set of demographic data providers;
wherein ordering the set of property data items based on the confidence in each property data item in the set of property data items to generate the ranking of property data items further comprises:
for each property data item in the set of property data items, calculating a confidence score based on a size of the corresponding subset of property data providers and an accuracy weight of each property data provider in the corresponding subset of property data providers; and
generating the ranking of property data items based on the confidence score of each property data item; and
wherein ordering the set of demographic data items based on the confidence in each demographic data item in the set of demographic data items to generate the ranking of demographic data items further comprises:
for each demographic data item in the set of demographic data items, calculating a confidence score based on a size of the corresponding subset of demographic data providers and an accuracy weight of each demographic data provider in the corresponding subset of demographic data providers; and
generating the ranking of demographic data items based on the confidence score of each demographic data item.

7. A method comprising:
accessing a property address in a real estate campaign, the property address associated with a telephone number;
generating a virtual telephone number associated with the real estate campaign;
transmitting a personalized message to the telephone number, the personalized message indicating the virtual telephone number;
at a first time, receiving an incoming call to the virtual telephone number;
in response to a caller number of the incoming call matching the telephone number:
retrieving a set of property data items from a set of property data providers based on the property address;
for each property data item in the set of property data items:
calculating a confidence score for the property data item based on the set of property data providers;
calculating a relevancy score for the property data item based on a set of characteristics of the real estate campaign; and
calculating a priority score for the property data item based on the relevance score for the property data item and the confidence score of the property data item;
ordering the set of property data items based on the priority score for each property data item in the set of property data items to generate a ranking of property data items;
displaying the set of property data items based on the ranking of property data items; and
at a second time within a threshold time period of the first time, forwarding the incoming call to a marketer telephone number associated with the real estate campaign.

8. The method of claim 7 further comprising:
in response to the caller number of the incoming call matching the telephone number:
retrieving a set of demographic data items from a set of demographic data providers based on the caller number;
for each demographic data item in the set of demographic data items:
calculating a confidence score for the demographic data item based on the set of demographic data providers;
calculating a relevancy score for the demographic data item based on similarities between a corresponding marketer data item and the demographic data item; and
calculating a priority score for the demographic data item based on the relevance score for the demographic data item and the confidence score of the demographic data item;
ordering the set of demographic data items based on the priority score for each demographic data item in the set of demographic data items to generate a ranking of demographic data items; and
displaying the set of demographic data items based on the ranking of demographic data items.

9. The method of claim 7 further comprising retrieving the set of real estate campaign characteristics of the real estate campaign, the set of real estate campaign characteristics comprising:
a type of the real estate campaign;
a capital allocation of the real estate campaign; and
a remaining uninvested capital of the real estate campaign.

10. The method of claim 7, wherein, for each property data item in the set of property data items, calculating the confidence score for the property data item based on the set of property data providers further comprises:
calculating a set of corroborating property data providers in the set of property data providers for the property data item;
accessing a set of accuracy weights for the set of corroborating property data providers; and
calculating the confidence score for the property data item based on the set of corroborating property data providers and the set of accuracy weights for the set of corroborating property data providers.

11. The method of claim 7, wherein retrieving the set of property data items from the set of property data providers based on the property address further comprises retrieving the set of property data items from the set of property data providers based on the property address, the set of property data items comprising a subset of property data items for a similar real estate listings to a property at the property address.

12. The method of claim 7, wherein retrieving the set of property data items from the set of property data providers based on the property address further comprises retrieving the set of property data items from the set of property data providers based on the property address, the set of property data items comprising an approximate monetary value associated with the property address.

13. The method of claim 7, wherein retrieving the set of property data items from the set of property data providers based on the property address further comprises retrieving the set of property data items from the set of property data providers based on the property address, the set of property data items comprising:
a set of images associated with the property address;
a floor area associated with the property address;
a plot size associated with the property address;
a number of bathrooms associated with the property address;
a number of bedrooms associated with the property address;
a number of total rooms associated with the property address;
utility records associated with the property address;
school district information associated with the property address; and
a map of a region associated with the property address.

14. A method comprising:
receiving a property address in a real estate campaign, the property address associated with a telephone number;
generating a virtual telephone number associated with the real estate campaign;
at a first time, receiving an incoming call to the virtual telephone number;
in response to matching a caller number of the incoming call to the telephone number:
retrieving a set of property data items for the property address associated with the telephone number;
retrieving a set of demographic data items associated with the telephone number;
at a second time within a threshold duration of the first time, displaying the set of property data items and the set of demographic data items at a call enrichment interface; and
at a third time subsequent to the second time, forwarding the incoming call to a marketer telephone number associated with the real estate campaign.

15. The method of claim 14:
further comprising, in response to matching the caller number of the incoming call to the telephone number:
ordering the set of property data items based on a confidence in each property data item in the set of property data items to generate a ranking of property data items; and
ordering the set of demographic data items based a confidence in each demographic data item in the set of demographic data items to generate a ranking of demographic data items; and
wherein, at the second time within the threshold duration of the first time, displaying the set of property data items and the set of demographic data items at the call enrichment interface further comprises, at the second time within the threshold duration of the first time, displaying the set of demographic data items and the set of property data items based on the ranking of property data items and the ranking of demographic data items at the call enrichment interface.

16. The method of claim 15, wherein, at the second time within the threshold duration of the first time, displaying the set of demographic data items and the set of property data items based on the ranking of property data items and the ranking of demographic data items at the call enrichment interface further comprises, at the second time within the threshold duration of the first time:
displaying the set of demographic data items higher in the call enrichment interface based on the ranking of demographic data items; and
displaying the set of property data items higher in the call enrichment interface based on the ranking of property data items.

17. The method of claim 14:
wherein, at the second time within the threshold duration of the first time, displaying the set of property data items and the set of demographic data items at the call enrichment interface further comprises, at the second time within the threshold duration of the first time, displaying the set of property data items and the set of demographic data items at the call enrichment interface at a computational device; and
wherein, at the third time subsequent to the second time, forwarding the incoming call to the marketer telephone number associated with the real estate campaign further comprises, at the third time subsequent to the second time, forwarding the incoming call to the computational device.

18. The method of claim 14 wherein, at the second time within the threshold duration of the first time, displaying the set of property data items and the set of demographic data items at the call enrichment interface further comprises, at the second time within the threshold duration of the first time, displaying the call enrichment interface comprising:
the set of property data items comprising:
a set of images associated with the property address;
a floor area associated with the property address; and
an approximate monetary value of the property address;
the set of demographic data items comprising:
a name associated with the telephone number;
an employment history associated with the name; and
a residential address associated with the name.

19. The method of claim 14:
recording a set of campaign data items based on the incoming call;
storing the set of campaign data items in association with the telephone number;
at a fourth time subsequent to the third time, receiving a second incoming call to the virtual telephone number; and
in response to matching a second caller number of the second incoming call to the telephone number:
retrieving an updated set of property data items for the property address associated with the telephone number;
retrieving an updated set of demographic data items associated with the telephone number;
retrieving the set of campaign data items associated with the telephone number;
at a fifth time within the threshold duration of the fourth time, displaying the set of property data items, the set of demographic data items, and the set of campaign data items at the call enrichment interface; and
at a sixth time subsequent to the fifth time, forwarding the second incoming call to a marketer telephone number associated with the real estate campaign.

20. The method of claim 19, wherein recording the set of campaign data items based on the incoming call further comprises:
recording a duration of the incoming call;
recording a date and time of the incoming call;
detecting a sentiment of the incoming call; and
recording an outstanding offer for the property address made during the incoming call.
